(19) United States
(12) Patent Application Publication
(10) Pub. No.: US 2006/0056510 A1
(43) Pub. Date: Mar. 16, 2006

(54) Method of coding video streams for low-cost multiple description at gateways

(75) Inventors: Mihaela Van Der Schaar, Ossining (US); Deepak Srinivas, Croton-on-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/538,582

(22) PCT Filed: Dec. 11, 2003
(86) PCT No.: PCT/IB03/05949

§ 371 Date: Jun. 15, 2005

Related U.S. Application Data
(60) Provisional application No. 60/434,056, filed on Dec. 17, 2002.

(51) Int. Cl. H04N 7/12

(52) U.S. Cl. 375/240.12

(57) ABSTRACT

The present insertion utilizes a data relationship between B-frame motion vectors (k^{(B)}) and P-frame motion vectors (k^{(P)}) to simplify merging and dividing of multiple descriptions (22, 24) at network nodes (28) such as gateways by avoiding the need to decompress and re-compress at least one of the multiple descriptions.

The present invention relates to video coding, and more particularly an improved system for splitting and combining multiple description video streams.

With the advent of digital networks such as the Internet, there has been a demand for the ability to provide multimedia communication in real time over such networks. However, such multimedia communications, compared to analog communication systems, have been hampered by the limited bandwidth provided by the digital networks. To adapt multimedia communications to such hardware environments, much effort has been made to develop video compression techniques that improve multimedia throughput under limited bandwidth conditions using predictive coded video streams. These efforts have led to the emergence of several international standards such as the MPEG-2 and MPEG4 standards issued by the Motion Pictures Experts Group (MPEG) of the ISO and the H.26L and H.263 standards issued by the Video Coding Experts Group (VCEG) of the ITU. These standards achieve a high compression ratio by exploiting temporal and spatial correlations in real image sequences, using motion-compensated prediction and transform coding.

More recently diversity techniques, using Multiple Description Coding (MDC), have been employed to increase the robustness of communication systems and storage devices. Examples of such systems enhanced by diversity techniques include packet networks, wireless systems using multi-path and Doppler diversity and Redundant Arrays of Inexpensive Disks (RAIDs).

Present diversity techniques using MDC have worked best in systems were the diversity issues are known at the source of the communication. In such instances MDC is used to break the data to be communicated into separate pathways each being separately coded by the source. One such form of MDC is based on splitting (FIG. 1) a video stream 10 at a gateway 12, for example, the odd-frames 14 into one description that is coded independently with MPEG, or the like, and the even-frames 16 into another description that is also coded independently with MPEG, or the like. Each of these streams is then transmitted and recombined at the destination. By implementing such methods, it will be appreciated that even if one stream is lost the data stream can be performed although at a reduced quality level.

Now with changes in the way information is delivered between wireless platforms and high-speed digital connections, the need for implementing diversity techniques at intermediate points in communication pathways is increasing in demand. By increasing the ways that hardware pathways are configured, a need has arisen for greater management of large multimedia data during communication. Presently, gateways that operate to channel high bandwidth channels between a plurality of low bandwidth stations have applied diversity techniques using MDC by transcoding all of the data. However, such solutions increase the overhead experienced at the gateway and may cause an increase in the transmission time. Both of these traits are undesirable. Thus, a need exists for a way to increase the advantages of diversity techniques during transmission, while minimizing the overhead imposed upon communication hardware.

The present invention utilizes a data relationship between B-frame motion vectors and P-frame motion vectors to simplify merging and dividing of multiple descriptions at gateways by avoiding the need to decompress and re-compress at least one of the multiple descriptions.

One aspect of the invention includes a data stream in which motion vectors of succeeding frames correspond to motion vectors of neighboring frames.

In one embodiment a gateway intermediate in the transmission of a data stream utilizes a method of managing multiple descriptions using the motion vector relationships to generate or merge multiple descriptions.

Other objects and advantages of the invention will become apparent from the foregoing detailed description taken in connection with the accompanying drawings, in which

FIG. 1 is a block diagram of a known multiple description technique;

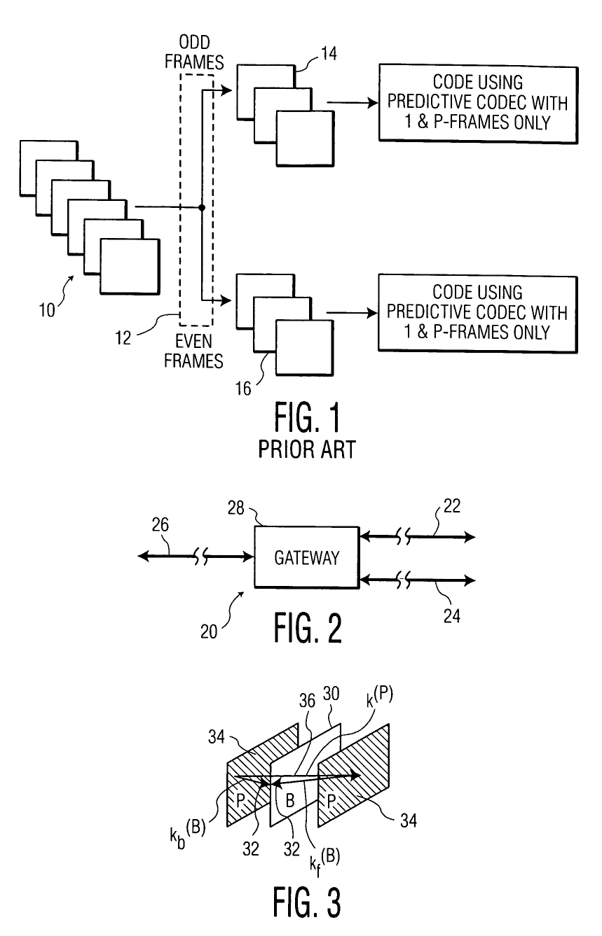

FIG. 2 is a block diagram of a communication pathway;

FIG. 3 is a block diagram of video frames in a predictive video stream;

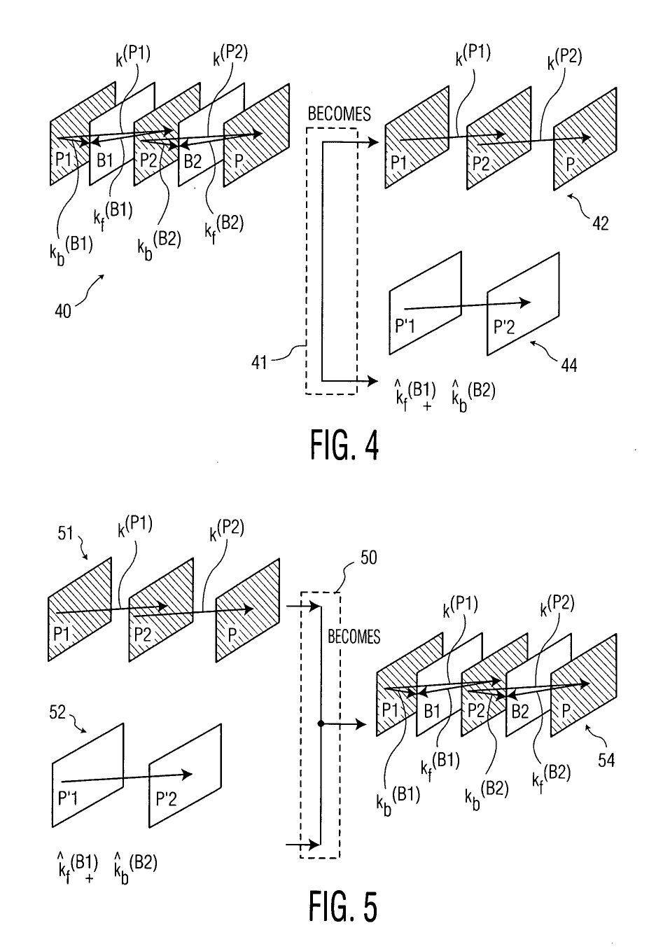

FIG. 4 is a block diagram of a multiple-description technique according to the present invention;

FIG. 5 is a block diagram of another multiple-description technique according to the present invention; and

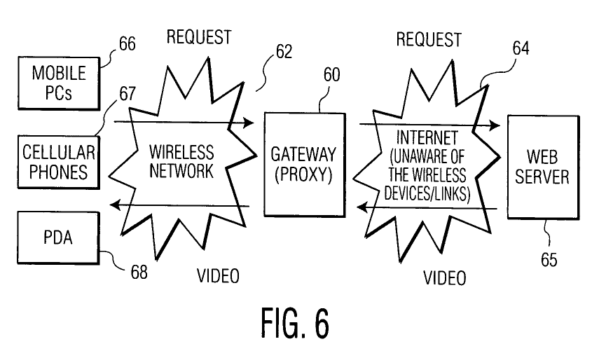

FIG. 6 is a block diagram of a wireless gateway.

With reference to the figures for purposes of illustration, the present invention relates to a system for implementing multi-channel transmission in a communications pathway of predictive scalable coding schemes. The present invention is presently described in connection with a communication system (FIG. 2) including a communication pathway 20 in which a communication channel includes multiple transmission pathways 22 and 24 that merge with a single transmission pathway 26 at a gateway 28 or other similar device for managing traffic where the pathways merge. It will be appreciated by those skilled in the art that this description is merely exemplary of the hardware environment in which this invention may be used and that the present invention may be implemented in other hardware environments as well. Advantageously, the present invention utilizes a mechanism that allows for a stream of multimedia data to be split into multiple descriptions without the overhead of full transcoding of the data in the stream.

The invention is implemented upon the realization that a stream of multimedia data compressed using predictive coding may be split into multiple descriptions for multiple transmission pathways without the need to decompress and re-compress the data for multiple pathways. Predictive coding techniques of the type suitable for this purpose include MPEG standards MPEG-1, MPEG-2 and MPEG-4 as well as ITT standards H.261, H.262, H.263 and H.26L. With reference to the MPEG standard description for purposes of illustration, a movie or video data stream is made up of a sequence of frames that when displayed in sequential order produce the visual effect of animation. Predictive coding produces reductions in the amount of data to be transmitted by only transmitting information that relates to differences between each sequential frame. Under the MPEG standard, predictive coding of frames is based off of an I-frame (Intra-coded frame) that contains all the information to ‘re-build’ a frame of video. It should be noted that I-frame only encoded video does not utilize predictive coding techniques as every frame of the file is independent and requires no other frame information. Predictive coding permits greater compression factors by removing the redundancy from one frame to the next, in other words sending a set of instructions to create the next frame from the current. Such frames are called P-frames (Predicted frames). However, a drawback in using I- and P-frame predictive encoding is that data can only be taken from the previous picture. Moving objects can reveal a background that is unknown in previous pictures, while it may be visible in later pictures. B-frames (Bi-directional frames) can be created from preceding and/or later I or P-frames. An I-frame with a series of successive B- and P-frames, up to the next I-frame is called a GOP (Group of Pictures). An example of a GOP for broadcasting has the structure IBBPBBPBBPBB and is referred to as IPB-GOP.

One method of sending multimedia data through two or more pathways uses Multiple Description Coding (MDC). MDC has been shown to be an effective technique for robust communication over wireless systems using multi-path and Doppler diversity and Redundant Arrays of Inexpensive Disks (RAIDs), and also over the Internet. Currently, if an MPEG or H.26L coded or any other predictive coded video stream of data is transmitted through the Internet and then at the gateway it needs to be split into 2 multiple description video streams that better fit the channel characteristics of the down-link (e.g. wireless systems using multi-path) while preserving the same coding format as before, the video data is fully decoded and re-encoded. However, the present invention covers a system that allows the gateway to easily split a data stream into multiple descriptions without expensive full transcoding while still allowing for more resilient transmission. As will be described below this savings in time and format is accomplished by coding the hierarchy of motion vectors in a particular format. The particular coding format is based on the observation that the motion-vectors for the B-frames are not very different from part of the motion-vectors (MVs) used for P-frames.

Normally, independent MVs are computed for B-frames. However (FIG. 3), good approximations or predictions for the B-frames' 30 MVs 32 can be computed from the P-frames' 34 MVs 36 as K_{b}(B) and K_{f}(B) depicted in FIG. 2 from the following formula:

$${\hat{k}}_{b}^{( B )} = {}_{\frac{1}{M + 1}}^{}{k}{}_{}^{( P )} ; {d}_{b}^{( B )} = {k}_{b}^{( B )} - {\hat{k}}_{b}^{( B )}$$

$${\hat{k}}_{f}^{( B )} = - {}_{( \frac{1}{M + 1} )}^{}{k}{}_{}^{( P )} ; {d}_{f}^{( B )} = {k}_{f}^{( B )} - {\hat{k}}_{f}^{( B )}$$

where M is the number of B-frames between two consecutive P-frames. Thus, the B-frames' Mvs could be computed from P-frame MVs and conversely. This coding format of the motion vectors is not preferred in current standardized video coding schemes, but can be implemented with no change in the standards. However, it shows that more accurate motion trajectories can be predicted from sub-sampled trajectories available, i.e. the B-frames' MVs scan be predicted from the P-frames' MVs.

### EXAMPLES

1. Splitting a Data Stream into Two Pathways

With reference to FIG. 4, the video data is transmitted from the server through a data channel, for example, but not by way of limitation, through the Internet. The video data, transmitted as a single predictive stream 40, then encounters a node 41 along the data channel such as a proxy or gateway. For purposes of this application the terms node, gateway and proxy may be used interchangeably. At the proxy, the stream is split into 2 separate descriptions 42 and 44. To eliminate the complexity associated with full re-encoding of the streams at the proxy, the video stream transmitted through the channel 40 is coded using an IPB GOP-structure, while the two descriptions 42 and 44 transmitted over the wireless link use IP GOP-structures. It will be appreciated by those skilled in the art that due to these restrictions, the performance of the coding scheme is reduced. Nevertheless, in this way, one MD 42 needs no re-coding at all, while for the other MD 44, the motion estimation at the proxy is no longer necessary, since the MVs for the MDs can use \hat{k}_{b}^{(B)} and the of the \hat{k}_{f}^{(B)} next frame to determine the MVs between P-frames or I and P-frames. Thus, the transition between a single channel 40 to two descriptions 42 and 44 can be performed easily by re-coding only the texture data. All macroblocks without MVs can be coded as intra-blocks. Also, if the proxy allows higher complexity processing, further refinements “d” of these estimations can be computed. For instance, a new lower complexity motion estimation can be performed but using a small search window (e.g. 8 by 8 pixels) centered at \hat{k}^{(P)} to find a more accurate motion vector that would lead to a lower residual (e.g. Maximum Absolute Difference) for the newly created P-frame. The computation of the MVs and refinements “d” can be derived from the relationship decribed above as follows:
\hat{k}^{(P)}=k_{f}^{(B)}−k_{b}^{(B)}; d^{(P)}=k^{(P)}−\hat{k}^{(P)}
assuming that in this example there was only 1 B-frame in the initial bitstream between two consecutive P-frames. Note also that this is just an example and analogous equations can be derived if a different number of B-frames are present between 2 consecutive P-frames. In an alternate embodiment, the refinements “d” can be computed at the server and sent in a separate stream through the Internet.
2. Merging a Data Stream from Two Pathways

With reference to FIG. 5, if the video stream is received by a proxy 50 over the Internet using two MDs 51 and 52 and the data is further transmitted wirelessly as a single stream 54, the reverse operation takes place. The Mvs for the B-frames can be estimated initially as \hat{k}_{f}^{(B)} and \hat{k}_{b}^{(B)}. So initially, \hat{k}_{f}=k_{f} and \hat{k}_{b}=k_{b}. Then, if the proxy allows higher complexity processing, further refinements “d” of these estimations can be computed. For instance, a new lower complexity motion estimation can be performed but using a small search window (e.g. 8 by 8 pixels) centered at \hat{k}_{f}^{(B)} and \hat{k}_{b}^{(B)} to find a more accurate motion vector that would lead to a lower residual (e.g. Maximum Absolute Difference) for the newly created B-frame. In this case, only the texture coding of the B-frames needs to be re-coded. The computation of the MVs and refinements “d” use the same relationships as set forth above as follows:

$${\hat{k}}_{b}^{( B )} = {}_{\frac{1}{M + 1}}^{}{k}{}_{}^{( P )} ; {d}_{b}^{( B )} = {k}_{b}^{( B )} - {\hat{k}}_{b}^{( B )}$$

$${\hat{k}}_{f}^{( B )} = - {}_{( \frac{1}{M + 1} )}^{}{k}{}_{}^{( P )} ; {d}_{f}^{( B )} = {k}_{f}^{( B )} - {\hat{k}}_{f}^{( B )}$$

where M is the number of newly created B-frames between two consecutive available P-frames. Note also that this is just an example and analogous equations can be derived if a different number of B-frames are created between 2 consecutive P-frames. In an alternate embodiment, the refinements “d” can be computed at the server and sent in a separate stream through the Internet together with the second MD.

It will be appreciated by those skilled in the art that the proposed method can be employed for any predictive coding scheme using Motion-estimation, such as MPEG-1, 2, 4 and H.263, H.26L.

It will further be appreciated by those skilled in the art that another advantage of this method resides in the fact that error recovery and concealment can be performed easier. This is because the redundant description of the MVs can be used to determined the MVs for the lost frame.

Finally those skilled in the art will appreciate that this method can be employed for robust, multi-channel transmission of “predictive” scalable coding schemes, such as Fine Granularity Scalable (FGS). This method can be used without MPEG-4 standard modifications and thus can be easily employed.

Uses in Gateway Processing:

With reference to FIG. 6, the present invention has application in gateway configurations in order to cope with the various network and device characteristics in the down-link. The gateway can be located in the home, i.e. a residential gateway, in the 3G network, i.e. a base-station or the processing can be distributed across multiple gateways/nodes. In such instances the gateway 60 connects a Local Area Network (LAN) 62 to the Internet 64. As shown in FIG. 6, a web server 65 or the like may be enabled to communicate with local devices 66-68. In instances where the LAN 62 is a wireless down-link, devices may include, but are not limited to, mobile PCs 66, Cellular Telephones 67 or Portable Data Assistants (PDAs) 68. In such instances the web server 65 and down-link devices 66-68 are both unaware of the communication pathways that the data travels. A stream of video, when transmitted between the devices, may require dynamic configurations in which for example the mobile PCs may demand multiple data channels to increase bandwidth to the gateway. Or the communication between the gateway and the web server may communicate through multiple data channels. In each instance it will be appreciated that the gateway serves to break up the data transmission to service the either the down-link or up-link node. The present invention as described in examples 1 and 2 above may be implemented in each of these instance to provide a seamless transition at the gateway between the up-link and down-link nodes regardless of the number of data channels used.

Currently, if an MPEG or H.26Lcoded or any other predictive coded video stream is transmitted through the Internet and then at the gateway it needs to be split into 2 multiple descriptions video streams that better fit the channel characteristics of the down-link (e.g. wireless systems using multi-path) while preserving the same coding format as before, the video data is fully decoded and re-encoded.

By implementing the present invention as described above in which a relationship is established between the B-frames' MVs and P-frames' MVs, the present process allows at the gateway easy splitting of an MPEG or H.26L coded data or any other predictive coded video stream into two multiple descriptions video streams that preserve the same coding format as before or results in merging of two multiple descriptions MPEG or H.26L coded or any other predictive coded video streams into a single coded format that preserves the same coding format as before without full decoding and re-encoding of the stream. It will be appreciated that with the proposed mechanism a considerable amount of the computational complexity at the gateway can be reduced.

While the present invention has been described in connection with what are presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

1. A network node for transmitting a stream of prediction encoded video data (40) formed from at least one description transmission comprising:
at least one connection (22, 24, 26, 62, 64) to a network having a plurality of data channels; and
a bandwidth manager (28, 60) for selectively changing the number of description transmissions making up said stream of prediction encoded video data;
wherein at least one of the description transmissions after changing the number of description transmissions retains the same prediction encoding as at least one of the description transmissions before changing the number of description transmissions.

2. The network node of claim 1 having at least two connections (22, 24, 26, 62, 64) to a network and being configured as a gateway (28, 60).

3. The network node of claim 1 wherein:
said stream of prediction encoded video data (40) includes encoded I-frames, P-frames and B-frames interconnected by motion vectors (k^{B}, k^{P}) when transmitted as a single description, and the motion vectors for said B-frames are generated in relation to motion vectors of neighboring P-frames;
said bandwidth manager (28, 60) being adapted to convert B-frame motion vectors (k^{B}) to and from P-frame motion vectors (k^{P});
wherein a stream of video data (40) in a single description having I-frames, P-frames and B-frames is converted to and from multiple descriptions (42, 44) having I-frames and P-frames.

4. The network node of claim 3 wherein the B-frame motion vectors (k^{B}) are generated with a correlation to P-frame motion vectors (k^{P}).

5. The network node of claim 4 wherein said B-frame motion vectors (k^{B}) correlate to neighboring P-frame motion vectors (k^{P}).

6. The network node of claim 1 wherein the number of descriptions are increased and the bandwidth manager (28, 60) includes means for generating at least one additional description.

7. The network node of claim 1 wherein the number of descriptions are decreased and the bandwidth manager (28, 60) includes means for merging at least two of said descriptions.

8. A data stream of prediction-encoded video data (40, 54) comprising:
at least one reference frame (I);
at least one first predicted frame (P) having a motion vector (k^{P}) referencing a previous frame;
at least one second predicted frame (B) having a motion vector (k^{B}) referencing a succeeding frame;
said motion vector (k^{B}) referencing a succeeding frame having a proportional relationship to said motion vector (k^{P}) referencing said previous frame.

9. The data stream of claim 8 including:
a plurality of reference frames (I);
a plurality of first predicted frames (P);
a plurality of second predicted frames (B);
said frames being organized and compressed in said stream to create a sequence of video (40, 54);
wherein said sequence may be divided into at least two sequences (42, 44; 51, 52) during transmission using the relationship of the first and second frame motion vectors (k^{P}, K^{B}).

10. The data stream of claim 8 wherein said second predicted frame (B) includes a motion vector (k^{B}) referencing a previous frame.

11. The data stream of claim 10 wherein said second predicted frame motion vectors (k^{B}) are adapted to convert to first predicted frame motion vectors (k^{P}) without decoding of said prediction encoded video data.

12. The data stream of claim 9 wherein:
said reference frame is an I-frame;
said first predicted frame is a P-frame;
said second predicted frame is a B-frame;
wherein said sequence of I-frame, P-frame and B-frames are adaptable to and from at least two sequences of I-frame and P-frame sequences using the relationship of B-frame and P-frame motion vectors.

13. The data stream of claim 9 wherein a first frame motion vector (k^{P}) converted from a second frame motion vector (k^{B}) corresponds to 1/(Q+1) of said motion vector referencing said previous frame to 1−1/(Q+1) of said motion vector referencing said succeeding frame, where Q is the number second frame motion vectors appearing in sequence between a pair of first frame motion vectors.

14. A method for multiple description conversion at gateways (41) comprising the steps of:
providing a description of video data (40) having I-frames, B-frames and P-frames in which motion vectors of said B-frames are generated in relation to said P-frames;
transmitting said description to said gateway (41);
dividing said description in multiple descriptions (42, 44) using the relationship of B-frames to P-frames; and
retaining prediction encoding from said description for at least one of the multiple descriptions.

15. The method of claim 14 wherein:
said dividing step includes organizing P-frames of said description into a first description and B-frames of said description into a second description such that P-frame descriptions remain intact;
creating P-frame motion vectors for said B-frames relying upon said relationship.

16. The method of claim 15 including merging said first and second descriptions (51, 52) back into a single description (54) at a second gateway (50).

17. The method of claim 16 wherein said dividing and merging steps are independent of a transmission source.

18. The method of claim 14 wherein said dividing step uses the relationship of B-frame motion vectors to P-frame motion vectors corresponding to a B-frame forward motion vector in 1−1/(M+1) proportion to a P-frame motion vector.

19. The method of claim 14 wherein said dividing step uses the relationship of B-frame motion vectors to P-frame motion vectors corresponding to a B-frame forward motion vector in 1/(M+1) proportion to a P-frame motion vector.

20. The method of claim 18 wherein said dividing step uses the relationship of B-frame motion vectors to P-frame motion vectors corresponding to a B-frame forward motion vector in 1/(M+1) proportion to a P-frame motion vector.
